(19) United States
(12) Patent Application Publication
(10) Pub. No.: US 2007/0198982 A1
(43) Pub. Date: Aug. 23, 2007

(54) Dynamic resource allocation for disparate application performance requirements

(75) Inventors: Joseph E. Bolan, Cary, NC (US); Zeynep Dayar, Cary, NC (US); Jeffery M. Franke, Apex, NC (US); Gregg K. Gibson, Apex, NC (US); Shane M. Lardinois, Durham, NC (US); Aaron E. Merkin, Holly Springs, NC (US); William B. Schwartz, Apex, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/359,253

(22) Filed: Feb. 21, 2006

(51) Int. Cl. G06F 9/46

(52) U.S. Cl. 718/104

(57) ABSTRACT

Embodiments of the invention address deficiencies of the art in respect to dynamic computing resource allocation, and provide a method, system and computer program product for dynamic resource allocation for disparate application performance requirements. In one embodiment of the invention, a resource allocation data processing system can include a shared resource pool including resources and a resource configurator coupled to the shared resource pool. The system further can include a service processor coupled to the resource configurator, wherein the service processor can include an application programming interface (API) exposing methods for commanding the resource configurator to configure the resources in the shared resource pool.

### BACKGROUND OF THE INVENTION

1. Field of the Invention

The present invention relates to the field of resource allocation and more particularly to allocating resources based upon application performance requirements.

2. Description of the Related Art

Resource allocation refers to the configuration of computing resources to service the processing requirements of hosted application logic. Computing resources often characterize hardware components including memory, disk storage and network bandwidth. Computing resources just as frequently characterize software and firmware components such as application server instances and service components. In both circumstances, the performance of hosted application logic usually relates directly to the amount of computing resources allocated to support the operation of the application logic.

High availability also relates to the allocation of computing resources, excepting that in the case of high availability, maximum performance is valued less than reliability. In this regard, whereas high performance systems support computationally intensive application logic, high availability systems support mission critical application logic—even at the expense of high performance. To achieve high availability, redundant computing resources are assigned to replace allocated computing resources in a failover mode so as to ensure availability of application logic irrespective of any failure conditions which may arise.

The divergent nature of high performance systems and high availability systems often results in the configuration of two separate resource pools: one resource pool configured to support high performance computing; and, another resource pool configured to support high availability computing. Separate resource pools can be required because, for many different host platforms, the configuration of computing resources occurs statically at power-on self test (POST) and changes to the static configuration require the powering down and re-configuration of the computing resources through a basic input output system (BIOS) set up routine.

As it will be recognized by the skilled artisan, however, maintaining separate resource pools for application logic having different performance requirements can be wasteful in terms of computing resources. Specifically, oftentimes computing resources can go unused when application logic requiring high performance when executing, is not executing. Likewise, computing resources can go unused when application logic requiring high availability when executing, is not executing. Yet further, post-configuration changes in resource configuration cannot be readily translated into different allocations to address the post-configuration changes in resource configuration.

### BRIEF SUMMARY OF THE INVENTION

Embodiments of the invention address deficiencies of the art in respect to dynamic computing resource allocation, and provide a novel and non-obvious method, system and computer program product for dynamic resource allocation for disparate application performance requirements. In one embodiment of the invention, a resource allocation data processing system can include a shared resource pool including resources and a resource configurator coupled to the shared resource pool. The system further can include a service processor coupled to the resource configurator, wherein the service processor can include an application programming interface (API) exposing methods for commanding the resource configurator to configure the resources in the shared resource pool.

Finally, the system can include resource provisioning/workload management logic including program code enabled to configure the resources through the service processor to support both mission critical applications through a high availability configuration of the resources, and performance critical applications through a high performance configuration of the resources. In one aspect of the invention the resource configurator can include a BIOS including selectable availability modes for the resources. In another aspect of the invention, the resource configurator can be an oversubscription policy manager for resources in the shared resource pool.

In another embodiment of the invention, a method for dynamically configuring resources in a shared resource pool can include querying a service processor for the shared resource pool to obtain a selection of available configurations for the resources in the shared resource pool and determining resource requirements for a mission critical application to be supported by resources in the shared resource pool. Also, the method can include selecting one of the available configurations in order to support the resource requirements determined for the mission critical application. Selecting one of the available configurations in order to support the resource requirements determined for the mission critical application can include selecting an oversubscription policy for the resources in order to support high availability requirements determined for the mission critical application.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a data processing system configured for dynamic resource allocation for disparate application performance requirements;

FIG. 2 is a flow chart illustrating a process for dynamic hardware resource allocation for disparate application performance requirements; and,

FIG. 3 is a flow chart illustrating a process for dynamic oversubscription policy management for resources in a shared resource pool for disparate application performance requirements.

### DETAILED DESCRIPTION OF THE INVENTION

Embodiments of the invention provide a method, system and computer program product for dynamic resource allocation for disparate application performance requirements. In accordance with an embodiment of the present invention, a common computing resource pool can be established to support both applications preferring high performance and other applications preferring high availability. A number of computing resources required to support the applications preferring high performance can be identified, and a number of computing resources required to support the applications preferring high-availability further can be identified. Subsequently, the resources in the common resource pool can be configured to address both the number of computing resources required to support the applications preferring high performance and the number of computing resources required to support the applications preferring high-availability.

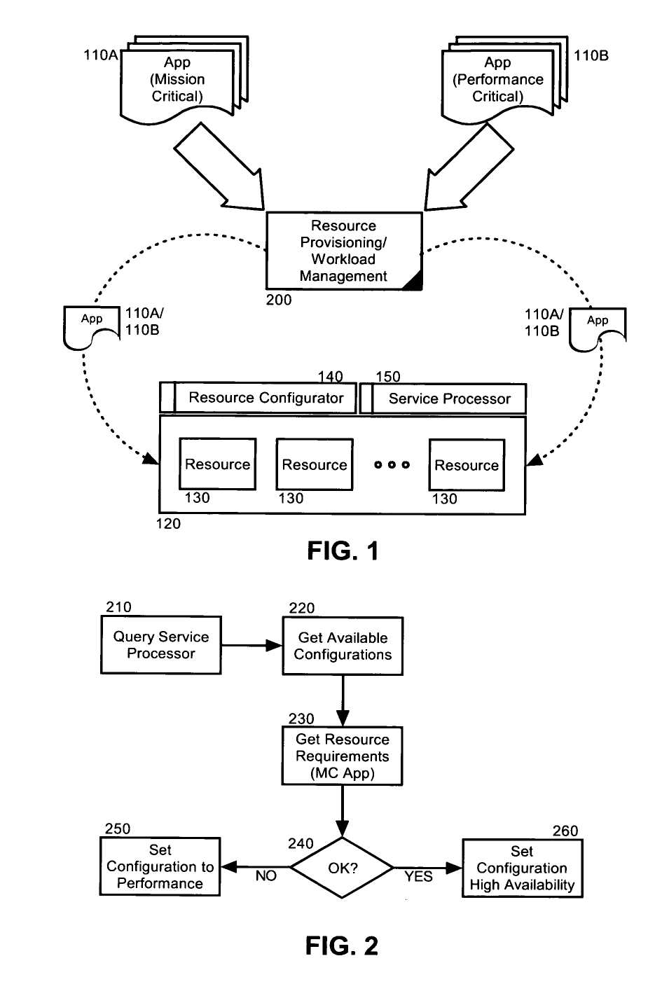

In illustration of an exemplary embodiment, FIG. 1 is a schematic illustration of a data processing system configured for dynamic resource allocation for disparate application performance requirements. The data processing system can include a shared resource domain 120 including one or more shared resources 130. The shared resources 130 can include hardware resources including configurable memory utilized both by mission critical application instances 110A and performance critical applications 110B. Alternatively, the shared resources 130 can include hardware resources such as shared power sources or cooling sources like a cooling fan.

Notably, the shared resource domain 120 can include a resource configurator 140 and a service processor 150. The resource configurator 140 can include logic enabled to establish configuration settings for the shared resources 130, such as BIOS logic. Alternatively, the resource configurator 140 can include logic enabled to enforce an oversubscription policy for the resources 130 in the shared resource domain 120. In this regard, the logic can determine a level of redundancy in available resources 130 in the shared resource domain 120, if any level at all. The shared resource domain 120, itself, can include a common pool of resources such as hardware resources in a host computing platform. These hardware resources can include configurable memory, power supplies and cooling fans, to name only a few hardware resources.

The service processor 150, by comparison, can expose an API to the resource configurator 140 such that external logic can access and manage the configuration of the resources 130 in the shared resource domain 120. In particular, resource provisioning/workload management logic 200 can be coupled to the service processor 150 and enabled to invoke methods in the service processor 150 for managing the resources 130 of the shared resource pool 120. The resource provisioning /workload management logic 200 further can be enabled to provisioning selected ones of the resources 130 in the shared resource pool 120 for hosting both mission critical applications 110A and performance critical applications 110B.

In operation, the resource provisioning/workload management logic 200 can query the service processor 150 to determine whether a configuration of the resources 130 in the shared resource pool 120 can accommodate the high availability requirements of the mission critical applications 110A. If so, the resources 130 can be configured in a high availability mode. Otherwise, the resources 130 can be configured for high performance. As such, in the case of hardware resources, the resource configurator 140 can direct the allocation of a portion of the resources 130 for use by a mission critical application 110A in order to ensure redundancy of the resources 130 when facing a failover condition. Otherwise, the resource configurator 140 can direct the allocation of additional resources 130 for use by performance critical applications 110B to ensure the maximum performance of the data processing system.

In further illustration, FIG. 2 is a flow chart illustrating a process for dynamic hardware resource allocation for disparate application performance requirements. Notably, the process can be performed within workload management logic for provisioning hardware resources to support both mission critical applications and performance critical applications. Beginning in block 210, the service processor can be queried to enumerate the resources in a shared resource domain, and in block 220 the possible availability configurations for the resources can be retrieved from the service processor.

In block 230, the resource requirements for managed mission critical applications can be determined. In decision block 240, if it is determined that the resources in the shared resource domain can satisfy the redundancy requirements of the mission critical applications, in block 260, the configuration for the resources of the shared resource domain can be configured in a high availability mode to ensure the requisite level of redundancy of the resources. Otherwise, in block 250, the configuration for the resources of the shared resource domain can be configured in a high performance mode to ensure a high level of resource utilization for performance critical applications.

Exemplary aspects of the foregoing embodiment can include the dynamic configuration of memory to provide for memory module redundancy in the event of an uncorrectable error or a correctable threshold. Consequently, the shared resource pool of memory can fail over to the “hot spare” memory module to ensure high availability for hosted mission critical applications. The dynamic configuration can be managed externally by a workload manager through the API exposed by the service processor. The actual configuration of the resources can be performed within the program code of the BIOS on initialization.

Exemplary aspects of the foregoing embodiment also can include the dynamic configuration of memory resources among multiple different levels of availability modes. Each different mode can include different supporting pre-requisites such as the presence of available ports or the presence of an identical configuration of memory modules. The proper mode can be selected according to the availability requirements of the mission critical applications and the pre-requisite configuration of the resources. Examples include the selection of a mirrored mode for hot replace, hot add mode of segmented memory arrays, performance mode and thirty-two (32) error correction code (ECC) mode.

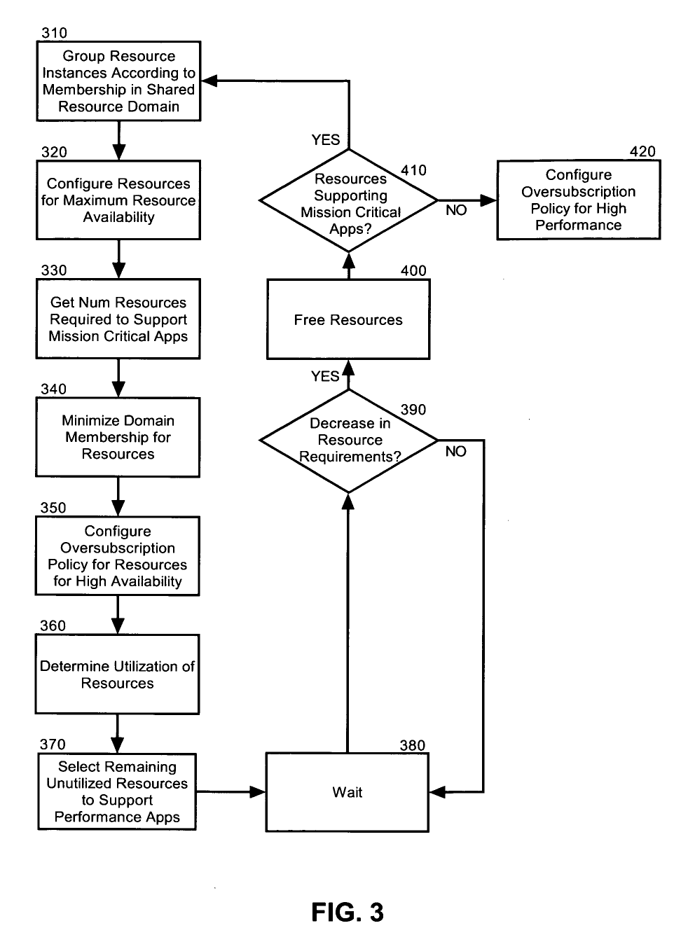

The dynamic configuration of resources in a shared resource pool can include the management of an oversubscription policy for resources in a shared resource pool. In illustration, FIG. 3 is a flow chart illustrating a process for dynamic oversubscription policy management for resources in a shared resource pool for disparate application performance requirements. Beginning in block 310, the resources of the data processing system can be grouped together according to membership in a common shared resource domain. Subsequently, in block 320, the resources in the target shared resource domain can be configured for maximum availability.

In block 330, a number of resources required to support a selection of mission critical applications can be determined and in block 340, the number of resources required can be associated with the domain membership in order to minimize domain membership for the resources. In block 350, an oversubscription policy can be configured for the resources so as to provide high availability to support the mission critical applications. Thereafter, in block 360, the actual utilization of the resources can be determined and in block 370, underutilized resources which remain can be selected to support a set of performance critical applications.

In block 380, the process can wait and then in decision block 390 it can be determined if a decrease in resource requirements has occurred. If no, the process can again wait in block 380. However, if in decision block 390 it is determined that a decrease in resource requirements has occurred, in block 400, the now underutilized resources can be freed for use by other applications. Thereafter, in decision block 410, it can be determined if any remaining resources are utilized in support of the mission critical applications. If not, in block 420 the oversubscription policy for the resources can be set to high performance (thereby allowing substantial oversubscription of the resources). Otherwise, the process can return to block 310 and the process can repeat iteratively in order to optimally establish an oversubscription policy for selected resources in the shared resource domain.

The embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A resource allocation data processing system comprising:
a shared resource pool comprising a plurality of resources;
a resource configurator coupled to the shared resource pool;
a service processor coupled to the resource configurator, the service processor comprising an application programming interface (API) exposing methods for commanding the resource configurator to configure the resources in the shared resource pool; and,
resource provisioning/workload management logic comprising program code enabled to configure the resources through the service processor to support both mission critical applications through a high availability configuration of the resources, and performance critical applications through a high performance configuration of the resources.

2. The system of claim 1, wherein the resources are hardware resources.

3. The system of claim 2, wherein the hardware resources comprise at least one power supply.

4. The system of claim 2, wherein the hardware resources comprise memory modules.

5. The system of claim 2, wherein the hardware resources comprise at least one cooling source.

6. The system of claim 2, wherein the resource configurator is a basic input output system (BIOS) for a host computing platform hosting the hardware resources in the shared resource pool.

7. The system of claim 2, wherein the BIOS comprises a plurality of selectable availability modes for the hardware resources.

8. The system of claim 3, wherein the resource configurator is an oversubscription policy manager for resources in the shared resource pool.

9. The system of claim 7, wherein the availability modes comprises at least one mode for configurable memory modules selected from the group consisting of a mirrored mode for hot replace, a hot add mode of segmented memory arrays, a performance mode and a thirty-two (32) error correction code (ECC) mode.

10. The system of claim 9, wherein the availability modes are associated with pre-requisite conditions limiting a selection of any one of the modes, the pre-requisite conditions comprising at least one condition selected from the group consisting of available ports and an identical configuration of memory modules.

11. A method for dynamically configuring resources in a shared resource pool, the method comprising:
querying a service processor for the shared resource pool to obtain a selection of available configurations for the resources in the shared resource pool;
determining resource requirements for a mission critical application to be supported by resources in the shared resource pool; and,
selecting one of the available configurations in order to support the resource requirements determined for the mission critical application.

12. The method of claim 11, wherein selecting one of the available configurations in order to support the resource requirements determined for the mission critical application, comprises selecting an oversubscription policy for the resources in order to support high availability requirements determined for the mission critical application.

13. The method of claim 11, wherein selecting one of the available configurations in order to support the resource requirements determined for the mission critical application, comprises:
selecting a high availability configuration for the resources responsive to determining that the resources in the resource pool are able to support the resource requirements for the mission critical application; and,
otherwise selecting a high performance configuration for the resources responsive to determining that the resource in the resource pool are not able to support the resource requirements for the mission critical application.

14. The method of claim 12, further comprising repeating the querying, determining and selecting steps iteratively responsive to changes in resource requirements for the mission critical application.

15. The method of claim 12, further comprising initially selecting a high availability oversubscription policy for all of the resources in the shared resource pool.

16. A computer program product comprising a computer usable medium embodying computer usable program code for dynamically configuring resources in a shared resource pool, the computer program product comprising:
computer usable program code for querying a service processor for the shared resource pool to obtain a selection of available configurations for the resources in the shared resource pool;
computer usable program code for determining resource requirements for a mission critical application to be supported by resources in the shared resource pool; and,
computer usable program code for selecting one of the available configurations in order to support the resource requirements determined for the mission critical application.

17. The computer program product of claim 16, wherein the computer usable program code for selecting one of the available configurations in order to support the resource requirements determined for the mission critical application, comprises computer usable program code for selecting an oversubscription policy for the resources in order to support high availability requirements determined for the mission critical application.

18. The computer program product of claim 16, wherein the computer usable program code for selecting one of the available configurations in order to support the resource requirements determined for the mission critical application, comprises:
computer usable program code for selecting a high availability configuration for the resources responsive to determining that the resources in the resource pool are able to support the resource requirements for the mission critical application; and,
computer usable program code for otherwise selecting a high performance configuration for the resources responsive to determining that the resource in the resource pool are not able to support the resource requirements for the mission critical application.

19. The computer program product of claim 17, further comprising repeating the querying, determining and selecting steps iteratively responsive to changes in resource requirements for the mission critical application.

20. The computer program product of claim 17, further comprising computer usable program code for initially selecting a high availability oversubscription policy for all of the resources in the shared resource pool.
